(19) United States
(12) Patent Application Publication
(10) Pub. No.: US 2010/0245178 A1
(43) Pub. Date: Sep. 30, 2010

(54) PORTABLE ELECTRONIC DEVICE

(75) Inventors: Shih-Wei Hsieh, Taipei City (TW); Shyh-Tirng Fang, Tai-Nan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/410,511

(22) Filed: Mar. 25, 2009

(51) Int. Cl. H01Q 1/24

(52) U.S. Cl. 343/702

(57) ABSTRACT

A portable electronic device is provided. The portable electronic device includes a housing, a first circuit board, an antenna, a second circuit board and a metal sheet. The first circuit board is disposed in the housing, including a first ground element, a first edge and a second edge. The antenna is disposed on the first circuit board near to the first edge, wherein the antenna transmits a wireless signal, and a resonance current is generated on the first ground element. The second circuit board is disposed in the housing, including a second ground element and a third edge. The metal sheet is disposed in the housing, insulated from the first ground element, wherein the metal sheet is near to the second edge and the third edge, and the metal sheet couples the first ground element to guide the resonance current from the first ground element to the second ground element.

### BACKGROUND OF THE INVENTION

1. Field of the Invention

The present invention relates to a portable electronic device, and in particular relates to a portable electronic device with low specific absorption rate (SAR).

2. Description of the Related Art

Specific absorption rate (SAR) is a measure of the rate at which radio frequency (RF) energy is absorbed by human body when exposed to radio-frequency electromagnetic field. It is defined as the power absorbed per mass of tissue and has units of Watts per kilogram. SAR is usually averaged either over the whole body, or over a small sample volume (typically 1 g or 10 g of tissue). The value cited is then the maximum level measured in the body part studied over the stated volume or mass. It may be calculated from the electric field within the tissue as:

$$SAR = \frac{σ {\vert E \vert}^{2}}{2 ρ} ,$$

where σ represents the sample electrical conductivity, |E| represents the magnitude of the electric field and p represents the sample density.

For conventional portable electronic devices (for example, personal digital assistants or cell phones), circuit board ground elements are sporadically disposed due to their multifunctional requirements and space limitations. Therefore, higher SAR is obtained from conventional portable electronic devices.

To reduce the specific absorption rate of portable electronic devices, the size of the circuit board is increased, or the antenna power is decreased. However, increasing the size of circuit boards is contrary to the trend for miniaturization. Decreasing the antenna power decays signal transmission of the antenna.

As well, a microwave absorbing material may be utilized to change the electric field intensity distribution of conventional portable electronic devices. However, using the microwave absorbing material also decays signal transmission of the antenna for conventional portable electronic devices as the microwave absorbing material absorbs power therein. Additionally, the cost of the microwave absorbing material is high, thus increasing the cost of conventional portable electronic devices.

### BRIEF SUMMARY OF THE INVENTION

A detailed description is given in the following embodiments with reference to the accompanying drawings.

In an embodiment of the invention, a portable electronic device is provided. The portable electronic device comprises a housing, a first circuit board, an antenna, a second circuit board and a metal sheet. The first circuit board is disposed in the housing, wherein the first circuit board comprises a first ground element, a first edge and a second edge, and the first edge is opposite to the second edge. The antenna is disposed on the first circuit board near to the first edge, wherein the antenna transmits a wireless signal, the wireless signal has a wavelength λ, and a resonance current is generated on the first ground element according to the wireless signal. The second circuit board is disposed in the housing, wherein the second circuit board comprises a second ground element, a third edge and a fourth edge, and the third edge is opposite to the fourth edge. The metal sheet is disposed in the housing, insulated from the first ground element, wherein the metal sheet is near to the second edge and the third edge, and the metal sheet couples the first ground element to guide the resonance current from the first ground element to the second ground element.

Utilizing the embodiment of the invention, the metal sheet couples the first ground element to guide the resonance current from the first ground element to the second ground element. Therefore, unifying the electric field distribution, resulting in decreased specific absorption rate. As well, the total electric field intensity is not decreased, and antenna transmission is not influenced.

### BRIEF DESCRIPTION OF THE DRAWINGS

The present invention can be more fully understood by reading the subsequent detailed description and examples with references made to the accompanying drawings, wherein:

FIG. 1a shows a portable electronic device of a first embodiment of the invention;

FIG. 1b is a side view of the portable electronic device of the first embodiment of the invention;

FIG. 2 shows a portable electronic device of a second embodiment of the invention;

FIG. 3a shows a portable electronic device of a third embodiment of the invention;

FIG. 3b shows a portable electronic device of a modified example of the third embodiment;

FIG. 4 shows a portable electronic device of a fourth embodiment of the invention;

FIG. 5a shows a portable electronic device of a fifth embodiment of the invention;

FIG. 5b shows a portable electronic device of a modified example of the fifth embodiment;

FIG. 5c shows a portable electronic device of a modified example of the fifth embodiment;

FIG. 6a shows a portable electronic device of a sixth embodiment of the invention; and

FIG. 6b shows a portable electronic device of a modified example of the sixth embodiment.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

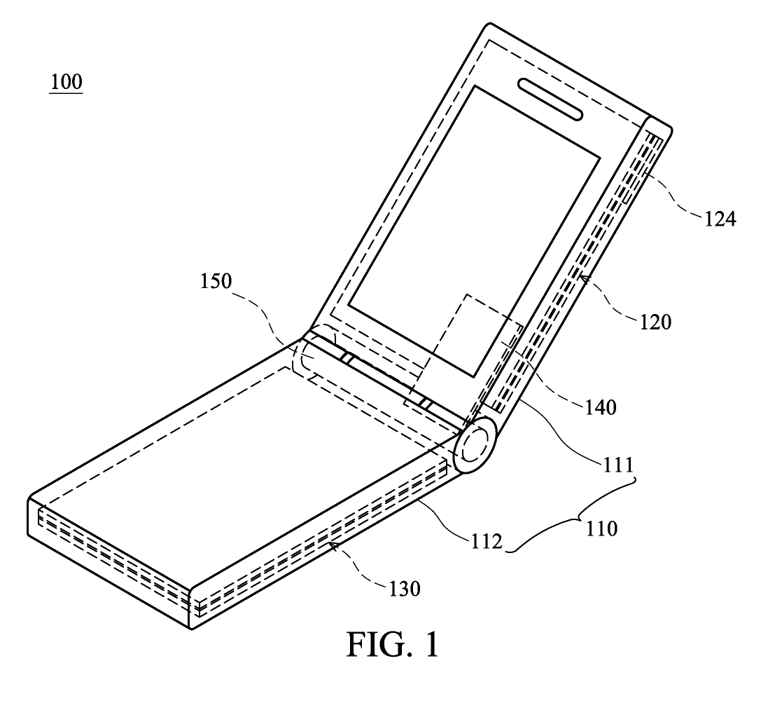

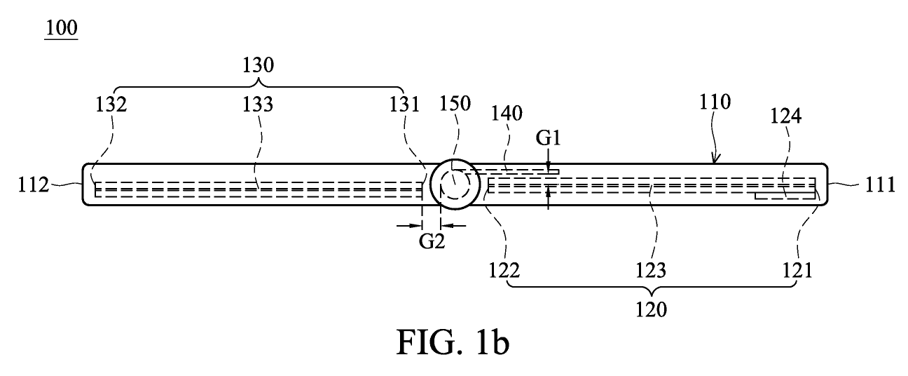

FIGS. 1a and 1b show a portable electronic device 100 of a first embodiment of the invention, comprising a housing 110, a circuit board 120, an antenna 124, a circuit board 130 and a metal sheet 140. The housing 110 comprises a body 112 and a cover 111. The cover 111 pivots on the body 112 via a hinge 150. The circuit board 120 is disposed in the cover 111 comprising a ground element 123 and edges 121 and 122. The edge 121 is opposite to the edge 122. The antenna 124 is disposed on the circuit board 120 near the edge 121. The antenna 124 transmits a wireless signal having a wavelength λ. A resonance current is generated on the ground element 123 according to the wireless signal. The circuit board 130 is disposed in the body 112. The circuit board 130 comprises a ground element 133 and edges 131 and 132, and the edge 131 is opposite to the edge 132. The metal sheet 140 is disposed in the cover 111 and separated (insulated) from the ground element 120, wherein the metal sheet 140 is near to the edges 122 and 131, and the metal sheet 140 couples the ground element 123 to guide the resonance current from the ground element 123 to the ground element 133 through the electromagnetic (EM) fields formed between the metal sheet 140 and the ground element 123, and between the hinge 150 and the ground element 133. Therefore, the current is uniformly distributed and a lower SAR is obtained.

In the first embodiment, the metal sheet 140 is parallel and corresponds to the circuit board 120. A gap G1 is formed between the metal sheet 140 and the ground element 123 to generate the EM field. The gap G1 may be less than 3 mm. A dimension of the metal sheet may substantially be 5 mm×5 mm.

In the first embodiment, the hinge 150 is a conductive element, and the metal sheet 140 is electrically connected to the hinge 150. The hinge 150 is located between the circuit board 120 and the circuit board 130. The hinge 150 is separated (insulated) from the ground element 123 and the ground element 133. A gap G2 is formed between the second ground element 133 and the hinge 150 to generate the EM field. The second gap G2 may be less than 3 mm.

By utilizing the first embodiment of the invention, a metal sheet couples a first ground element to guide the resonance current from the first ground element to a second ground element. Therefore, because the electric field distribution is uniform, the SAR is decreased. Additionally, the metal sheet is electrically connected to the hinge (conductive element), and composes a conductor therewith. Thus, the current guiding efficiency is improved, and the dimension of the metal sheet is reduced to 5 mm×5 mm. As well, the total electric field intensity is not decreased, and antenna transmission is not negatively influenced as with conventional design.

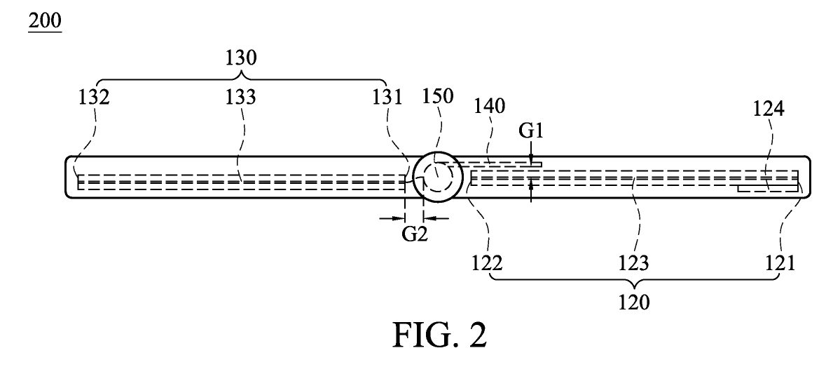

FIG. 2 shows a portable electronic device 200 of a second embodiment of the invention, comprising a housing 110, a circuit board 120, an antenna 124, a circuit board 130 and a metal sheet 140. The difference between the first and second embodiments is the connectivity way between the hinge 150 and the circuit board 130. In the second embodiment of the invention, the hinge 150 is electrically connected to the circuit board 130.

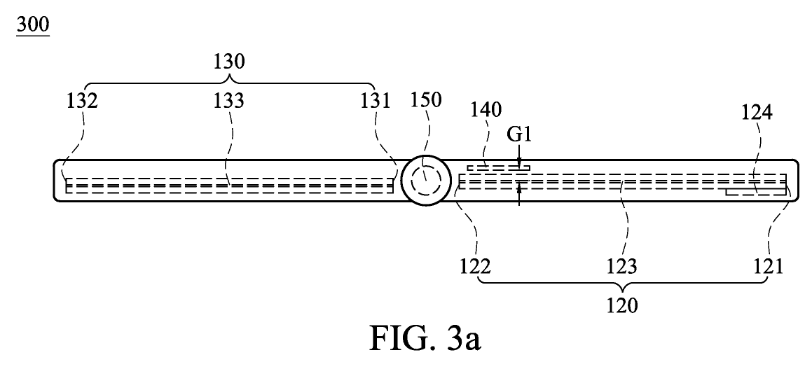

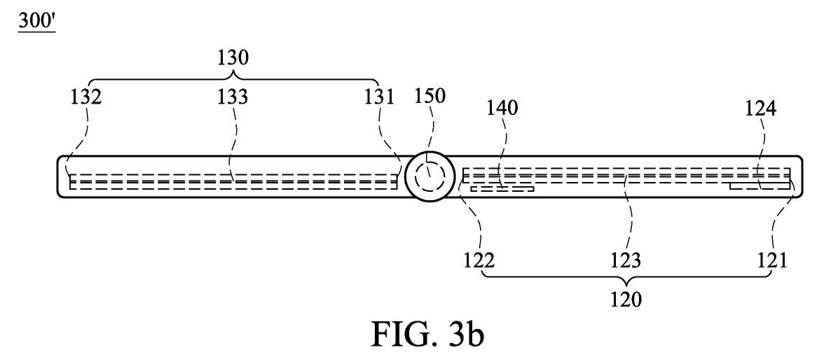

FIG. 3a shows a portable electronic device 300 of a third embodiment of the invention, comprising a housing 110, a circuit board 120, an antenna 124, a circuit board 130 and a metal sheet 140. The differences between the first and third embodiments are described below. A distance between the metal sheet 140 and the ground element 133 may be smaller than 0.1λ. The separation of the metal sheet 140 from the hinge 150 may cause an increased dimension of the metal sheet 140. A dimension of the metal sheet 140 may substantially be 50 mm×10 mm.

FIG. 3b shows a portable electronic device 300′ of a modified example of the third embodiment, wherein the metal sheet 140 is located on a lower side of the first circuit board 120.

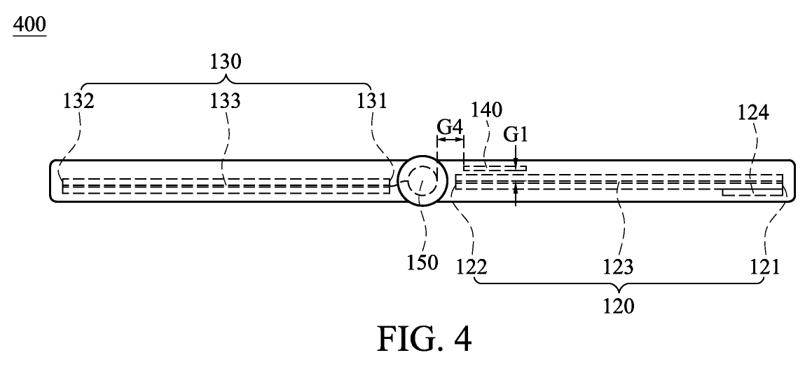

FIG. 4 shows a portable electronic device 400 of a fourth embodiment of the invention, comprising a housing 110, a first circuit board 120, an antenna 124, a second circuit board 130 and a metal sheet 140. The differences between the first and fourth embodiments are described hereinafter. In the fourth embodiment, the metal sheet 140 is separated (insulated) from the hinge 150. A gap G4 is formed between the hinge 150 and the metal sheet 140. The gap G4 may be less than 3mm. The hinge 150 may be electrically connected to the ground element 133 to improve current guiding efficiency.

In the first to fourth embodiments, the portable electronic devices are clamshell electronic devices.

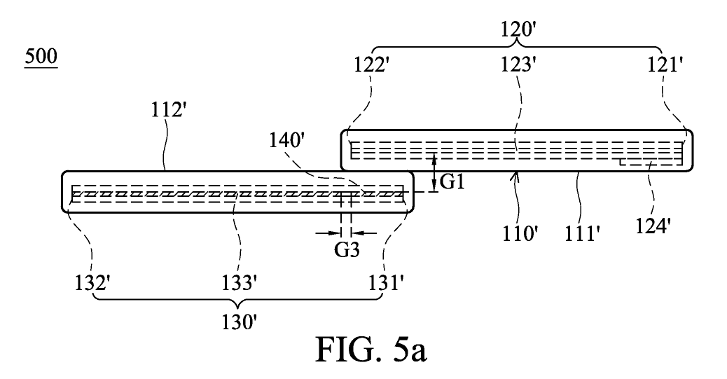

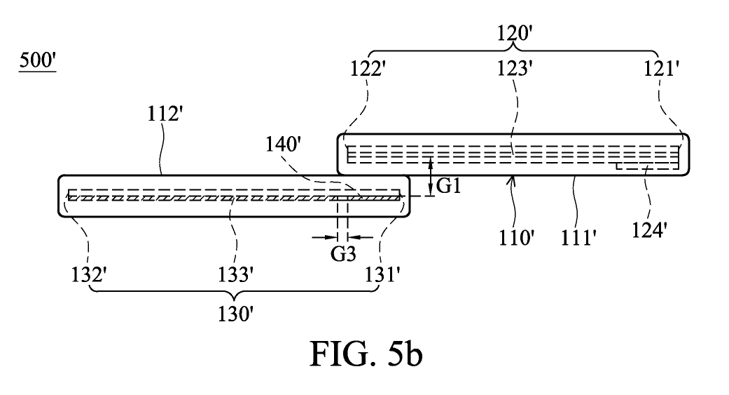

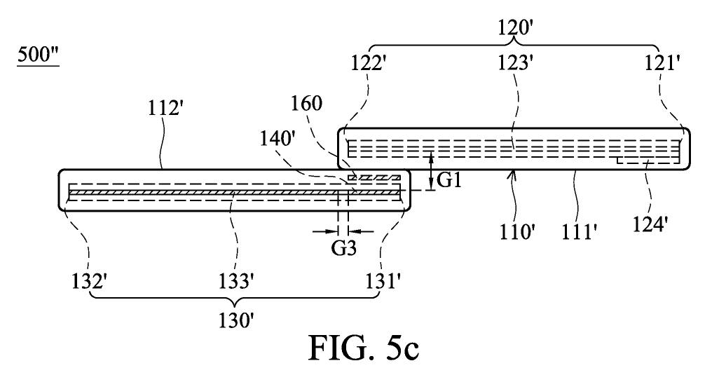

FIG. 5a shows a portable electronic device 500 of a fifth embodiment of the invention, comprising a housing 110′, a circuit board 120′, an antenna 124′, a circuit board 130′ and a metal sheet 140′. The housing 110′ comprises a body 112′ and a cover 111′. The cover 111′ slides on the body 112′. The circuit board 120′ is disposed in the cover 111′ comprising a ground element 123′ and edges 121′ and 122′. The edge 121′ is opposite to the edge 122′. The antenna 124′ is disposed on the circuit board 120′ near the edge 121′. The antenna 124′ transmits a wireless signal having a wavelength λ. A resonance current is generated on the ground element 123′ according to the wireless signal. The circuit board 130′ is disposed in the body 112′. The circuit board 130′ comprises a ground element 133′ and edges 131′ and 132′, where the edge 131′ is opposite to the edge 132′. The metal sheet 140′ is disposed in the housing and separated (insulated) from the ground element 120′, and the metal sheet 140′ is near to the edge 122′ and the edge 131′, and the metal sheet 140′ couples the ground element 123′ to guide the resonance current from the ground element 123′ to the ground element 133′ through the EM fields formed between the metal sheet 140′ and the ground element 123′, and between the metal sheet 140′ and the circuit board 133′. Therefore, the current is uniformly distributed and a lower SAR is obtained.

In the fifth embodiment, the metal sheet 140′ is parallel and corresponding to the circuit board 120′. A gap G1 is formed between the metal sheet 140′ and the ground element 123′ to generate the EM field. The first gap G1 may be less than 0.1λ. A dimension of the metal sheet may substantially be 50 mm×10 mm.

In the fifth embodiment, the metal sheet 140′ and the ground element 133′ are located on a same plane. A gap G3 is formed between the metal sheet 140′ and the ground element 133′ to generate the EM field. The gap G3 may be less than 0.1λ or less than 3 mm. The metal sheet 140′ is separated (insulated) from the ground element 133′.

In the fifth embodiment of the invention, the metal sheet 140′ and the ground element 133′ are sandwiched in the circuit board 130′.

FIG. 5b shows a portable electronic device 500′ of a modified example of the fifth embodiment, wherein the metal sheet 140′ is located on a surface of the circuit board 130′.

In the fifth embodiment, the portable electronic device is a slider electronic device, wherein when the cover 111′ is in a first position, the edge 121′ corresponds to the edge 131′, and the edge 122′ corresponds to the edge 132′, and when the cover 111′ is in a second position, the edge 122′ corresponds to the edge 131′.

FIG. 5c shows a portable electronic device 500″ of a modified example of the fifth embodiment, which further comprises a high dielectric constant element 160 disposed between the metal sheet 140′ and the ground element 123′ to improve current guiding efficiency. The high dielectric constant element 160 can also be utilized in other embodiments of the invention.

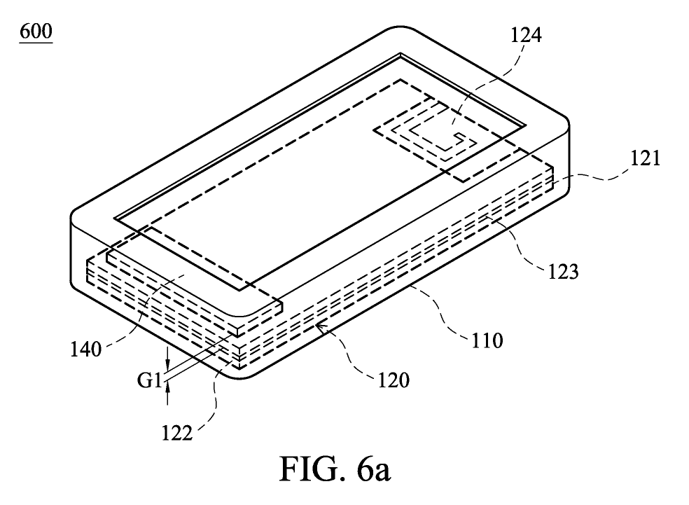

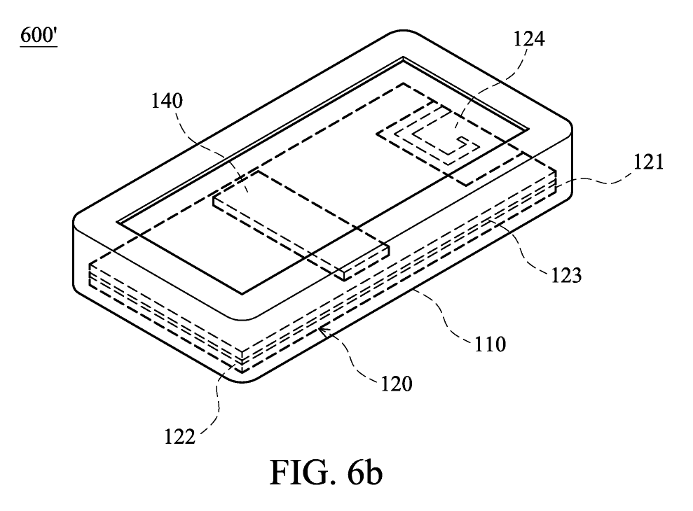

FIG. 6a shows a portable electronic device 600 of a sixth embodiment of the invention, comprising a housing 110, a circuit board 120, an antenna 124 and a metal sheet 140. The circuit board 120 is disposed in the housing 110 comprising a ground element 123 and edges 121 and 122. The edge 121 is opposite to the edge 122. The antenna 124 is disposed on the circuit board 120 near the edge 121. The antenna 124 transmits a wireless signal having a wavelength λ. A resonance current is generated on the ground element 123 according to the wireless signal. The metal sheet 140 is disposed in the housing 110 and separated (insulated) from the ground element 123, the metal sheet 140 is near to the edge 122, and couples the ground element 123 to guide the resonance current spread on the ground element 123 uniformly through the electromagnetic (EM) fields formed between the metal sheet 140 and the ground element 123.

In the sixth embodiment, the metal sheet 140 is parallel and corresponds to the circuit board 120. A gap G1 is formed between the metal sheet 140 and the ground element 123. The gap G1 may be less than 3 mm. A dimension of the metal sheet may substantially be 50 mm×5 mm in width by length.

FIG. 6b shows a portable electronic device 600′ of a modified example of the sixth embodiment, wherein the metal sheet 140 corresponds to the center of the circuit board 120, and couples the ground element 123 to guide the resonance current spread on the ground element 123 uniformly.

In the above embodiments, the positioning of the metal sheet 140 may be further modified. For example, referring to FIG. 5a, the metal sheet 140′ may be disposed between the circuit board 120′ and the circuit board 130′ or disposed in the cover 111′.

In the embodiments of the invention, the position of the metal sheet can be chosen according to a hot-spot position of SARs detected by experimentation. As well, the metal sheet may be disposed on an inner wall of the housing.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a housing;
a first circuit board, disposed in the housing, wherein the first circuit board comprises a first ground element, a first edge and a second edge, and the first edge is opposite to the second edge;
an antenna, disposed on the first circuit board near to the first edge, wherein the antenna transmits a wireless signal, the wireless signal has a wavelength λ, and a resonance current is generated on the first ground element according to the wireless signal;
a second circuit board, disposed in the housing, wherein the second circuit board comprises a second ground element, a third edge and a fourth edge, and the third edge is opposite to the fourth edge; and
a metal sheet, disposed in the housing, insulated from the first ground element, wherein the metal sheet is near to the second edge and the third edge, and the metal sheet couples the first ground element to guide the resonance current from the first ground element to the second ground element.

2. The portable electronic device as claimed in claim 1, wherein the metal sheet is parallel and corresponds to the first circuit board, a first gap is formed between the metal sheet and the first ground element, and the first gap is smaller than 0.1λ.

3. The portable electronic device as claimed in claim 2, further comprising a conductive element, wherein the metal sheet is electrically connected to the conductive element, and the conductive element is located between the first circuit board and the second circuit board.

4. The portable electronic device as claimed in claim 3, wherein the conductive element is a hinge.

5. The portable electronic device as claimed in claim 3, wherein the conductive element is electrically connected to the second ground element.

6. The portable electronic device as claimed in claim 3, wherein the conductive element is insulated from the first ground element and the second ground element.

7. The portable electronic device as claimed in claim 3, wherein the first gap is smaller than 3 mm.

8. The portable electronic device as claimed in claim 7, wherein a second gap is formed between the conductive element and the second ground element, and the second gap is smaller than 3 mm.

9. The portable electronic device as claimed in claim 8, wherein a dimension of the metal sheet is 5 mm×5 mm.

10. The portable electronic device as claimed in claim 2, further comprising a conductive element, wherein the second ground element is electrically connected to the conductive element, and the conductive element is located between the first circuit board and the second circuit board.

11. The portable electronic device as claimed in claim 2, wherein the portable electronic device is a clamshell electronic device, the housing comprises a body and a cover, the first circuit board is disposed in the cover, the second circuit board is disposed in the body, and the cover pivots on the body.

12. The portable electronic device as claimed in claim 2, further comprising a high dielectric constant element, disposed between the metal sheet and the first ground element.

13. The portable electronic device as claimed in claim 1, wherein the metal sheet and the second ground element are located on a same plane, a first gap is formed between the metal sheet and the first ground element, a third gap is formed between the metal sheet and the second ground element, and the first gap and the third gap is smaller than 0.1λ.

14. The portable electronic device as claimed in claim 13, wherein the metal sheet is insulated from the second ground element.

15. The portable electronic device as claimed in claim 14, wherein the metal sheet is located on the second circuit board.

16. The portable electronic device as claimed in claim 14, wherein the metal is sandwiched in the second circuit board.

17. The portable electronic device as claimed in claim 12, wherein the third gap is smaller than 3 mm.

18. The portable electronic device as claimed in claim 17, wherein a dimension of the metal sheet is 50 mm×10 mm.

19. The portable electronic device as claimed in claim 11, wherein the portable electronic device is a slider electronic device, the housing comprises a body and a cover, the first circuit board is disposed in the cover, the second circuit board is disposed in the body, and the cover is moved between a first position and a second position related to the body.

20. The portable electronic device as claimed in claim 19, wherein when the cover is in the first position, the first edge is corresponding to the third edge, the second edge is corresponding to the fourth edge, and when the cover is in the second position, the second edge is corresponding to the third edge.

21. A portable electronic device, comprising:
a housing;
a first circuit board, disposed in the housing, wherein the first circuit board comprises a first ground element, a first edge and a second edge, and the first edge is opposite to the second edge;
an antenna, disposed on the first circuit board near to the first edge, wherein the antenna transmits a wireless signal, the wireless signal has a wavelength λ, and a resonance current is generated on the first ground element according to the wireless signal; and
a metal sheet, disposed in the housing, insulated from the first ground element, wherein the metal sheet is near to the second edge, and the metal sheet couples the first ground element to guide the resonance current spread on the first ground element uniformly.

22. A portable electronic device, comprising:
a housing;
a first circuit board, disposed in the housing, wherein the first circuit board comprises a first ground element, a first edge and a second edge, and the first edge is opposite to the second edge;
an antenna, disposed on the first circuit board near to the first edge, wherein the antenna transmits a wireless signal, the wireless signal has a wavelength λ, and a resonance current is generated on the first ground element according to the wireless signal; and
a metal sheet, disposed in the housing, insulated from the first ground element, wherein the metal sheet is corresponding to the center of the first circuit board, and the metal sheet couples the first ground element to guide the resonance current spread on the first ground element uniformly.
